(19) United States
(12) Patent Application Publication
(10) Pub. No.: US 2006/0105758 A1
(43) Pub. Date: May 18, 2006

(54) Method and apparatus to disable function of mobile station

(76) Inventor: Ruben E. Maislos, Or-Yehuda (IL)

Correspondence Address: PEARL COHEN ZEDEK LATZER, LLP, 1500 BROADWAY, 12TH FLOOR, NEW YORK, NY, 10036, US

(21) Appl. No.: 10/986,919

(22) Filed: Nov. 15, 2004

(51) Int. Cl. H04M 3/00; H04Q 7/20

(52) U.S. Cl. 455/420; 455/419; 455/456.1

(57) ABSTRACT

Briefly, a method an apparatus and a wireless communication system having a base station. The base station may include a locater to locate presence of the mobile station in a restricted area and a controller to send a reconfiguration signal to reconfigure a setup of the mobile station according to a desired restriction.

### BACKGROUND OF THE INVENTION

Wireless communication systems such as, for example, cellular communication systems may include a plurality of base stations and a plurality of mobile stations. For example, the base station may be cells, micro-cells and the like. In those systems, in order to receive a call, the base station may locate a recipient (e.g. a mobile station) presence in a coverage area of the base station, and may send a call command which may include at least a ring command, a phone number of a caller and the like. The recipient may receive the call command and may play a tune, sound a ring, vibrate, or may signal with lights according to the mobile station properties. In some areas the ring and/or the tune may be considered as a disturbance to the environment and should be avoided.

Certain public places such as, for example, hospitals, concert halls, public libraries, theaters, and the like, may use a radio frequency (RF) blocking device to block reception of RF signals by mobile stations that may be present in such public places.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic block diagram of a portion of a wireless communication system according to an exemplary embodiment of the present invention;

FIG. 2 is a schematic block diagram of a base station according to an exemplary embodiment of the present invention;

FIG. 3 is a schematic block diagram of a mobile station according to an exemplary embodiment of the present invention; and

FIG. 4 is an illustration of a flowchart of a method to reconfigure one or more properties of a mobile station by a base station according to exemplary embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like. For example, “plurality of mobile stations” describes two or more mobile stations

It should be understood that the present invention may be used in a variety of applications Although the present invention is not limited in this respect, the circuits and techniques disclosed herein may be used in many apparatuses such as receivers of a radio system Receivers intended to be included within the scope of the present invention include, by way of example only, wireless local area network (WLAN) receivers, two-way radio receivers, digital system receivers, analog system receivers, cellular radiotelephone receivers and the like.

Types of cellular radiotelephone systems intended to be within the scope of the present invention include, although are not limited to, Code Division Multiple Access (CDMA) and wideband CDMA (WCDMA) cellular radiotelephone portable devices for transmitting and receiving spread spectrum signals, Global System for Mobile communication (GSM) cellular radiotelephone, Time Division Multiple Access (TDMA), GPRS, Extended GPRS, and the like.

Some embodiments of the invention may be implemented, for example, using a machine-readable medium or article which may store an instruction or a set of instructions that, if executed by a machine (for example, by micro-cells and/or cellphones of wireless communication system, and/or by other suitable machines), cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

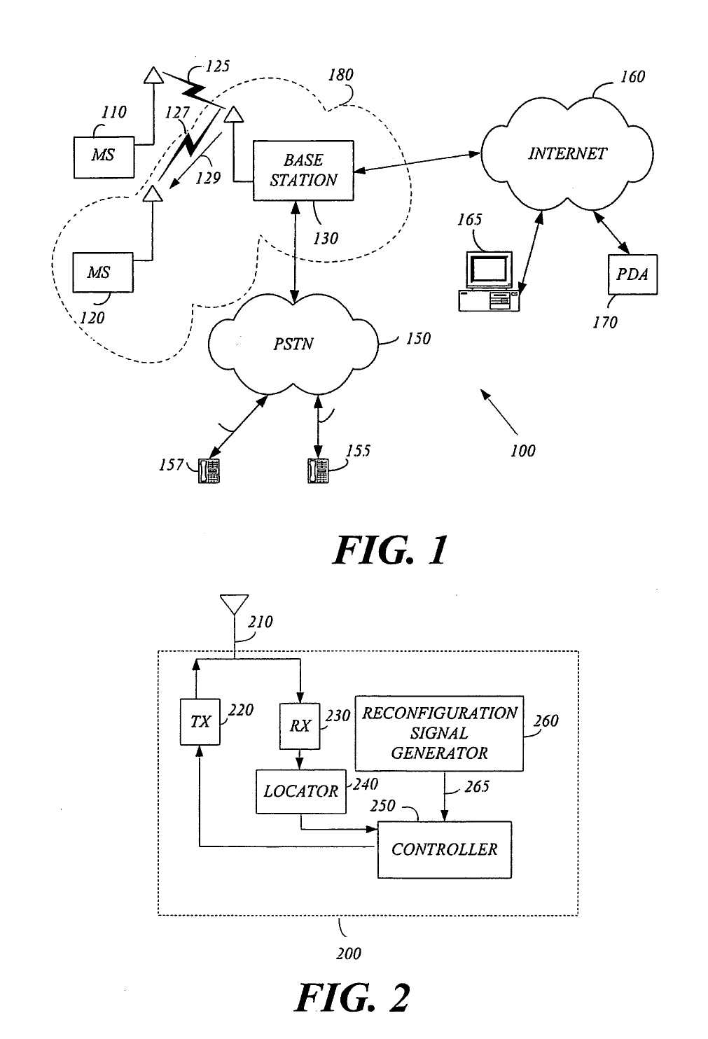

Turning to FIG. 1, a schematic block diagram of a portion of a cellular communication system 100 according to an exemplary embodiment of the invention is shown. Although the scope of the present invention is not limited in this respect, cellular communication system 100 may include mobile stations (MS) 110 and 120 and a base station (BS) 130. In some embodiments of the invention, BS 130 may be operably coupled to a public switched telephone network (PSTN) 150 to enable MS 110 and 120 to receive calls and/or to place calls to a telephone 155 and/or a facsimile machine 157. Furthermore, in some embodiments of the present invention, BS 130 may be operably coupled to the Internet 160, allowing MS 110 and 120 to access services and other entities over the Internet 160, if desired. For example, using an Internet connection, MS 110 and 120 may establish access to electronic mail services, surfing services, voice over Internet protocol (IP) telephone calls and the like. Those services may be provided to a user of a personal computer (PC) 165 and/or to a user of a personal digital assistant 170, if desired.

Although the scope of the present invention is not limited in this respect, MS 110 may receive a call form MS 120, for example, a voice call or a data call such as, for example, a text message, an image, a video clip and the like. BS 130 may deliver the call from MS 120 to MS 110 BS 130 via wireless links 125 and 127, if desired

According to an exemplary embodiment of the present invention, MS 120 may be roamed to a restricted area 180. In this embodiment of the present invention, BS 130 may disable MS 120 from sounding rings and/or rings tunes and/or any other audible alarm, if desired For example, BS 130 may send a reconfiguration signal 129 over air link 127 to disable a rings unit of MS 120, if desired. Alternatively or additionally, an exemplary restriction of restricted area 180 may include a restriction of electromagnetic radiation, e.g., transmission of RF signals. In this embodiment, reconfigure signal 129 may include one or more instructions to disable a transmitter of MS 120. In this example, MS 120 BS 130 may send reconfiguration signal 129 to disable the transmitter of MS 120, if desired. Thus, BS 130 may only send data messages to MS 120 and may not receive a reply from MS 120.

In some embodiments of the invention, the restrictions of restricted area 180 may include a restriction from using image capturing devices, such as, for example, a digital camera, a video camera or the like. In this embodiment, reconfiguration signal 129 may include one or more instructions to disable the operation of the image capturing device of MS 120. In this example, BS 130 may send reconfiguration signal 129 to MS 120 to disable the operation of an image capturing of MS 120, if desired. Although the scope of the present invention is not limited in this respect, reconfiguration signal 129 may include data, instructions, messages, commands or any other information that may enable BS 130 to reconfigure a setup of MS 120.

Turning to FIG. 2, a block diagram of a base station 200, according to an exemplary embodiment of the invention is shown. Although the scope of the present invention is not limited in this respect, base station 200 may be a cell and/or a micro-cell of a cellular communication system and may include an antenna 210, a transmitter (TX) 220, a receiver (RX) 230, a locator 240, a controller 250 and a reconfiguration signal generator 260. In some embodiments of the present invention antenna 210 may include an antenna array, a dipole antenna, a monopole antenna, a Yagi antenna, a directional antenna or the like.

Although the scope of the present invention is not limited in this respect, antenna 210 and receiver 230 may receive signals from a mobile station (e.g. mobile station 120) entering a restricted area (e.g. restricted area 180). In some embodiments of the invention, locater 240 may receive signals from the mobile station and may detect and/or locate the presence of the mobile station in the restricted area based on the received signals, if desired. For example, locater 240 may include a global positioning system (GPS) receiver, a proximity detection system, a radio triangulation system, and the like. In addition, locater 240 may receive signals such as, for example, handover signals to hand over the mobile station from one base station to another base station, paging signals or the like,

Although the scope of the present invention is not limited in this respect, reconfiguration signal generator 260 may generate a reconfiguration signal 265 Controller 250, for example, a microprocessor, may send reconfiguration signal 265 to reconfigure a setup of mobile station according to a desired restriction. According to some embodiments of the invention, the mobile station may be a handset and/or a cellular radiotelephone device, which may be configured to ring when receiving a call. According to this example, the desired restriction may be a restriction of sound telephone rings. According to this restriction, transmitter 220 may transmit, through antenna 210, reconfiguration signal 265 to disable the sound of rings from the cellular radiotelephone device, e.g., by reconfiguring the setup of the cellular radiotelephone device, although the scope of the present invention is not limited in this respect.

According to some other embodiments of the invention, locator 240 may be able to determine if the mobile station is entering and/or leaving the restricted area and may be able to instruct controller 250 to send the reconfiguration signal to disable and/or to enable one or more properties of the mobile station (e.g. MS 120) according to the leaving/entering status of the mobile station, if desired. For example, the properties of the mobile station may include a silence mode, a message mode, a meeting mode, a general mode or the like.

Although the scope of the present invention is not limited in this respect, in the silence mode the mobile station may not sound rings and/or ring tunes and may vibrate or blink with lights when a call is received. In the message mode the mobile station may be capable of receiving for example, text, voice, video, pictures or the like but may not be capable of transmitting voice, data and/or text. In the meeting mode the mobile station may not sound rings and/or ring tunes and/or may not be able to operate an image capturing device but may vibrate or blink with lights when receiving calls. In the general mode, the mobile station may be configured by a user according to a desired scheme. According to some embodiments of the invention, controller 250 may disable the transmitter of the mobile station, if desired.

Although the scope of the present invention is not limited in this respect, reconfiguration signal 265 may include instructions to reconfigured the mobile station to the silence mode, general mode, the meeting mode, the message mode or any other desirable mode. Furthermore, reconfiguration signal 265 may include instructions to disable the transceiver of the mobile station, to disable a rings unit and to enable a silence alarm unit of the mobile station, to disable the image capturing device or the like.

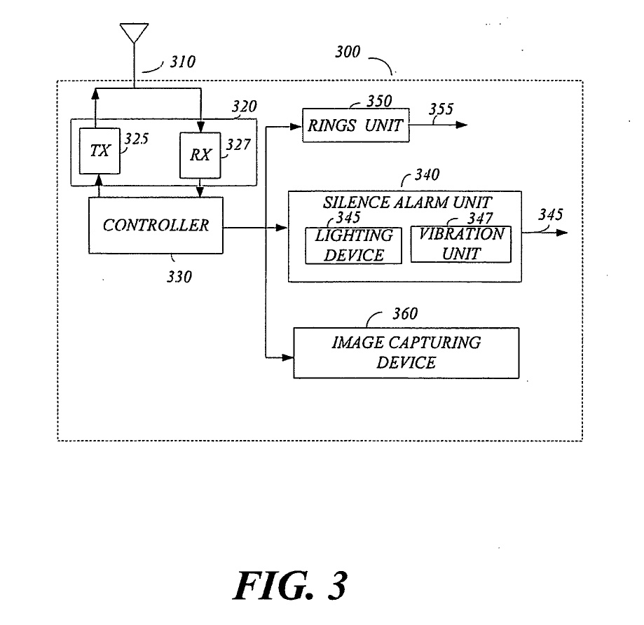

Turning to FIG. 3, a schematic block diagram of a mobile station 300 according to exemplary embodiments of the present invention is shown. Although the scope of the present invention is not limited to this respect, according to some exemplary embodiments of the invention, mobile station 300 may be a cellular mobile station and may include an antenna 310 for example, an internal antenna, a dipole antenna, etc., a transceiver 320, a controller 330, a silence alarm unit 340, a ring unit 350 and an image capturing device 360.

According to this exemplary embodiment of the invention, science alarm unit 340 may include a lighting device 345 and a vibration unit 347 and my send a silence alarm indicator 345 such as, for example blinking lights and/or vibrations, if desired. Ring unit 350 may generate a ring signal 355 when a call is received. Image capturing device 360 may include a scanner, a camera, a video camera, or the like.

In operation, according to at least one embodiment of the invention, a base station may send a reconfiguration signal, for example, reconfiguration signal 129, to mobile station 300. Antenna 310 may receive the reconfiguration signal. Transceiver 320 may include two portions, e.g., a transmitter 325 and a receiver 327. Receiver 327 may receive the reconfiguration signal and may transfer the reconfiguration signal to controller 330.

According to this exemplary embodiment of the invention, controller 330 may reconfigure mobile station 300 properties according to the reconfiguration signal. For example, controller 330 may switch mobile station 300 to silence mode by disabling ring unit 350 and enabling silence alarm unit 340, Furthermore, controller 330 may disable portions of transceiver 320. For example, controller 330 may disable transmitter 325 and/or may switch receiver 327 to a sleep mode, if desired.

Although the scope of the present invention is not limited in this respect, in some embodiments of the invention controller 330 may disable the operation of image capturing device 360 according to the reconfiguration signal, if desired. For example, the mobile station may be located in a restricted area, wherein the restriction may be to prevent capturing images, e.g., taking photos, scanning documents, filming video or the like. According to this example, the reconfiguration signal may include instructions to disable the operation of image capturing device 260, if desired.

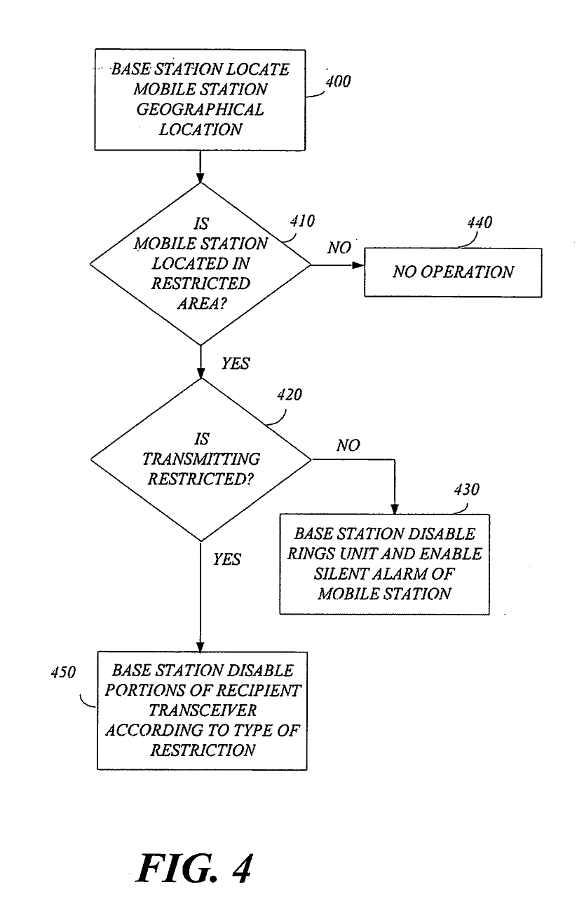

Turning to FIG. 4, a flowchart of a method to reconfigure one or more properties of a mobile station according to exemplary embodiments of the present invention is shown. Although the scope of the present invention is not limited to this respect, according to some exemplary embodiments of the invention, a base station, for example BS 130, may locate a respective geographic location of a mobile station e.g., MS 120 (text block 400) According to this exemplary method, if the respective geographic location of MS 120 is within a restricted area, for example, restricted area 180 (text block 410) and transmitting of RF signals is permitted (text box 420), base station 130 may transmit a reconfiguration signal e.g., reconfiguration signal 129, to disable one or more properties of the mobile station based on a restriction of the restricted area.

Although the scope of the present invention is not limited in this respect, for example, the reconfigured signal may disable the mobile station from sounding a ring signal, ring tunes and/or to disable an audible alarm unit of the mobile station. In addition, the reconfiguration signal may enable a silence ring indicator, if desired (text box 430). In some other embodiments of the invention the reconfiguration signal may disable the operation of a digital camera or a video camera that may be coupled to the mobile station, if desired.

In some embodiments of the invention, transmission of RF signals by the mobile station may be restricted (text box 420) In this case, the base station may disable portions of the mobile station (e.g. recipient) transceiver according to a type of the restriction (text box 450). For example, the reconfiguration signal may disable a transmitter of the mobile station and may switch a receiver to a sleep mode, if desired. In some embodiments of the invention, the base station, e.g. base station 130, may transmit a reconfiguration signal, e.g. reconfigure signal 129, to enable one or more disabled properties of the mobile station (e.g., mobile station 120), when the mobile station may be detected as leaving the restricted area (e.g., restricted area 180), although the scope of the present invention is not limited in this respect. For example, in other embodiments of the invention, another base station, e.g. outside the restricted area, may sense the leaving of the mobile station and may enable the disabled properties of the mobile station, if desired.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. An apparatus comprising:
a locater to locate presence of a mobile station in a restricted area; and
a controller to send a reconfiguration signal to reconfigure a setup of the mobile station according to a desired restriction.

2. The apparatus of claim 1, wherein the locator is able to determine if the mobile station enters the restricted area and to instruct the controller to send the reconfiguration signal to disable one or more properties of the mobile station.

3. The apparatus of claim 2, wherein the locator is able to determine if the mobile station leaves the restricted area and to instruct the controller to send the reconfiguration signal to enable the one or more properties disabled at the mobile station.

4. The apparatus of claim 1, wherein the reconfiguration signal comprises an instruction to disable at least a portion of the transceiver of the mobile station.

5. The apparatus of claim 1, wherein the reconfiguration signal comprises an instruction to disable the transmitter of the mobile station.

6. The apparatus of claim 1, wherein the reconfiguration signal comprises an instruction to reconfigure the mobile station to a silence mode.

7. The apparatus of claim 6, wherein the reconfiguration signal comprises an instruction to disable a rings unit and to enable a silence alarm unit of the mobile station.

8. The apparatus of claim 1, wherein the reconfiguration signal comprises an instruction to disable the operation of an image capturing device.

9. A method comprising:
locating presence of a mobile station in a restricted area and transmitting a reconfiguration signal to disable one or more properties of the mobile station based on a restriction of the restricted area.

10. The method of claim 9, wherein transmitting a reconfiguration signal comprises transmitting a reconfiguration signal to disable the mobile station from transmitting.

11. The method of claim 9, wherein transmitting a reconfiguration signal comprises transmitting a reconfiguration signal to disable the mobile station from sounding a ring signal and to enable a silence ring indicator.

12. The method of claim 9, wherein transmitting a reconfiguration signal comprises transmitting a reconfiguration signal to enable one or more disabled properties of the mobile station when leaving the restricted area.

13. The method of claim 9, wherein transmitting a reconfiguration signal comprises transmitting a reconfiguration signal to disable the operation of an image capturing device.

14. A wireless communication device comprising:
an antenna array to receive signals to enable locating a mobile station;
a locater to locate presence of the mobile station in a restricted area; and
a controller to send a reconfiguration signal to reconfigure a setup of the mobile station according to a desired restriction.

15. The wireless communication device of claim 14, wherein the locator is able to determine if the mobile station enters the restricted area and able to instruct the controller to send the reconfiguration signal to disable one or more properties of the mobile station.

16. The wireless communication device of claim 14, wherein the locator is able to determine if the mobile station leaves the restricted area and to instruct the controller to send the reconfiguration signal to enable the one or more properties disabled at the mobile station.

17. The wireless communication device of claim 14, wherein the reconfiguration signal comprises an instruction to disable at least a portion of the transceiver of the mobile station.

18. The wireless communication device of claim 14, wherein the reconfiguration signal comprises an instruction to disable the transmitter of the mobile station.

19. The wireless communication device of claim 14, wherein the reconfiguration signal comprises an instruction to reconfigure the mobile station to a silence mode.

20. The wireless communication device of claim 19, wherein the reconfiguration signal comprises an instruction to disable a rings unit and to enable a silence alarm unit of the mobile station.

21. The wireless communication device of claim 14, wherein the reconfiguration signal comprises an instruction to disable the operation of an image capturing device.

22. A wireless communication system comprising:
a base station having:
a locater to locate presence of the mobile station in a restricted area; and
a controller to send a reconfiguration signal to reconfigure a setup of the mobile station according to a desired restriction.

23. The wireless communication system of claim 22, wherein the locator is able to determine if the mobile station enters the restricted area and able to instruct the controller to send the reconfiguration signal to disable one or more properties of the mobile station.

24. The wireless communication system of claim 22, wherein the locator is able to determine if the mobile station leaves the restricted area and to instruct the controller to send the reconfiguration signal to enable the one or more properties disabled at the mobile station.

25. The wireless communication system of claim 22, wherein the reconfiguration signal comprises an instruction to disable at least a portion of the transceiver of the mobile station.

26. The wireless communication system of claim 22, wherein the reconfiguration signal comprises an instruction to disable the transmitter of the mobile station.

27. The wireless communication system of claim 22, wherein the reconfiguration signal comprises an instruction to reconfigure the mobile station to a silence mode.

28. The wireless communication system of claim 22, wherein the reconfiguration signal comprises an instruction to disable a rings unit and to enable a silence alarm unit of the mobile station.

29. The wireless communication system of claim 22, wherein the reconfiguration signal comprises an instruction to disable the operation of an image capturing device.

30. An article comprising: a storage medium, having stored thereon instructions, that when executed, result in:
locating presence of a mobile station in a restricted area and transmitting a reconfiguration signal to disable one or more properties of the mobile station base on a restriction of the restricted area.

31. The article of claim 30, wherein the instructions that result in transmitting a reconfiguration signal comprise instructions that result in disabling the mobile station from transmitting.

32. The article of claim 30, wherein the instructions that result in transmitting a reconfiguration signal comprise instructions that result in disabling the mobile station from sounding a ring signal and to enable a silence ring indicator.

33. The article of claim 30, wherein the instructions that result in transmitting a reconfiguration signal comprise instructions that result in enabling one or more disabled properties of the mobile station when leaving the restricted area.

34. The article of claim 30, wherein the instructions that result in transmitting a reconfiguration signal comprise instructions that result in disabling the operation of an image capturing device.
